(19) United States
(12) Patent Application Publication
(10) Pub. No.: US 2016/0327429 A1
(43) Pub. Date: Nov. 10, 2016

(54) LIGHT EMISSION TESTING DEVICE WITH A SHUTTER

(71) Applicant: ISMECA SEMICONDUCTOR HOLDING SA, La Chaux-de-Fonds (CH)

(72) Inventor: Sylvain VIENOT, Villers-le-Lac (FR)

(73) Assignee: ISMECA SEMICONDUCTOR HOLDING SA, La Chaux-de-Fonds (CH)

(21) Appl. No.: 15/113,791

(22) PCT Filed: Aug. 20, 2014
(86) PCT No.: PCT/EP2014/067774

§ 371 Date: Jul. 22, 2016

(30) Foreign Application Priority Data
Mar. 20, 2014 (CH) 00427/14

(51) Int. Cl. G01J 1/04; G01J 1/02; G01J 1/42

(52) U.S. Cl. CPC G01J 1/044; G01J 1/42; G01J 1/0223; G01J 1/0271; G01J 2001/4252

(57) ABSTRACT

A testing device for measuring the light characteristics of an electronic component includes an inlet at one end at which an electronic component can be presented for testing. A shutter is located at the inlet and is moveable between a first open position in which an electronic component can be received into the inlet, and a second closed position in which the shutter can overlay at least the majority of a nest on which said electronic component is supported, so that the shutter prevents light emitted by the electronic component from being diverted away from the testing device. The shutter includes at least one sliding door that can be slid to move the shutter into its first and second open positions. The at least one sliding door includes a cut out portion that defines said opening when the shutter is in its second closed position.

### FIELD OF THE INVENTION

The present invention concerns a testing device and in particular a light emission testing device, such as a light integrating sphere, which is used to test the light characteristics of an electronic component, such as an LED. In particular the present invention concerns a testing device which comprises a shutter which can open to allow the light emitting part of the electronic component (e.g LED) to be received into the testing device (e.g. light integrating sphere) for testing, and which can be closed prior testing so as to prevent light emitted by the of the electronic component from being dispersed by a nest on which the of the electronic component is supported.

### DESCRIPTION OF RELATED ART

The light characteristics of an LED are usually tested using a light integrating sphere. Typically the LED is supported on nest of a rotating table; the table rotates so that the LED located directly beneath an inlet of the light integrating sphere; while in this position the LED is then powered so that it emits light; the light emitted by the LED is received into the light integrating sphere where it is measured to determine the light characteristics of the LED.

In ensure accurate determination of the light characteristics of the LED, light loss should be minimised, so that substantially all of the light emitted by the LED should be received into the light integrating sphere. The prior art, such as CN102607696 and CN202869647U propose that the LED should be positioned as closely as possible to the inlet of the light integrating sphere to reduce light loss. Another solution, such as that proposed in CN203163875U, proposes to move both the LED and nest/platform on which the LED is supported, into the integrating sphere and then to close the integrating sphere using a sealing cover before testing.

A disadvantage associated with each of the existing solutions is that light which is emitted by the LED during testing is deflected by the nest/platform on which the LED is supported; the deflected light can lead to inaccurate determining of the light characteristics of the LED.

It is an aim of the present invention to obviate or mitigate at least some of the above-mentioned disadvantages.

### BRIEF SUMMARY OF THE INVENTION

According to the present invention a testing device for testing electronic components, the testing device comprising an enclosure which has an inlet at one end at which an electronic component can be presented for testing; a shutter located at the inlet, wherein the shutter is configured to be moveable between a first open position in which an electronic component to be tested can be received into the inlet, and a second closed position in which the shutter can overlay at least the majority of a nest on which said electronic component is supported, so that the shutter can prevent light emitted by the electronic component from being diverted away from the integrating sphere by at least the majority of the nest.

In the most preferred embodiment there is provided a testing device for testing electronic components, the testing device comprising an enclosure which has an inlet at one end at which an electronic component can be presented for testing; a shutter located at the inlet, wherein the shutter is configured to be moveable between a first open position in which an electronic component to be tested can be received into the inlet, and a second closed position in which the shutter can overlay at least the majority of a nest on which said electronic component is supported, so that the shutter can prevent light emitted by the electronic component from being diverted away from the integrating sphere by at least the majority of the nest, wherein the shutter comprises at least one sliding door, which can be slid to move the shutter into its first open position, and slid to move the shutter into its second closed position, wherein the at least one sliding door comprises a cut out portion which defines said opening when the shutter is in its second closed position.

The testing device is preferably a light integrating sphere for measuring the light characteristics of an electronic component which is an LED. Therefore according to an embodiment there is provided a light integrating sphere for measuring the light characteristics of an LED, the light integrating sphere comprising, an inlet at one end at which an LED can be presented for testing; a shutter located at the inlet, wherein the shutter is configured to be moveable between a first open position in which an LED to be tested can be received into the inlet, and a second closed position in which the shutter can overlay at least the majority of a nest on which said LED is supported, so that the shutter can prevent light emitted by the LED from being diverted away from the integrating sphere by at least the majority of the nest.

The shutter may be configured to define an opening the shape of the opening being the same shape, or substantially the same shape, as the shape of a cross section of the electronic component to be tested, so that in its closed position the shutter overlays at least the majority of nest on which the electronic component is supported so that the shutter can prevent light emitted by the electronic component from being diverted away from the enclosure by at least the majority of the nest.

The shape of the opening may be circular, rectangular, square or any other suitable shape. The shutter may be configured to define an opening the shape of the opening being the same shape, or substantially the same shape, as the shape of a cross section of the LED to be tested, so that in its closed position the shutter overlays at least the majority of nest on which the LED is supported so that the shutter can prevent light emitted by the LED from being diverted away from the integrating sphere by at least the majority of the nest. The shape of the opening may be circular, rectangular, square or any other suitable shape.

The shutter may be configured to define an opening the shape of the opening being the same shape, or substantially the same shape, as the shape of the perimeter of gripper fingers on the nest which grip the electronic component, so that in its closed position the shutter overlays at least the majority of nest on which the electronic component is supported. In this embodiment the shutter will not overlay the gripper fingers and the electronic component, so the gripper fingers and electronic component will remain exposed to inside of the enclosure through the opening when the shutter is in its closed position. However the gripper fingers preferably form a minority portion of the nest, such that since the shutter will overlay the other parts of the nest when in its closed position, the shutter will still prevent a majority of the nest from dispersing light emitted the electronic component under test.

The shutter may be configured to define an opening the shape of the opening being the same shape, or substantially the same shape, as the shape of the perimeter of gripper fingers on the nest which grip the LED, so that in its closed position the shutter overlays at least the majority of nest on which the LED is supported so that the shutter can prevent light emitted by the LED from being diverted away from the integrating sphere by at least the majority of the nest. In this embodiment the shutter will not overlay the gripper fingers and the LED, so the gripper fingers and LED will remain exposed to inside of the integrating sphere through the opening when the shutter is in its closed position. However the gripper fingers preferably form a minority portion of the nest, such that since the shutter will overlay the other parts of the nest when in its closed position, the shutter will still prevent a majority of the nest from dispersing light emitted the LED under test.

The shutter may be configured to define an opening the area of the opening being equal to, or substantially equal to, the area of a cross section of the electronic component to be tested so that in its closed position the shutter overlays at least the majority of nest on which the electronic component is supported so that the shutter can prevent light emitted by the electronic component from being diverted away from the enclosure of the testing device by at least the majority of the nest.

The shutter may be configured to define an opening the area of the opening being equal to, or substantially equal to, the area of a cross section of the LED to be tested so that in its closed position the shutter overlays at least the majority of nest on which the LED is supported so that the shutter can prevent light emitted by the LED from being diverted away from the integrating sphere by at least the majority of the nest.

The shutter may be configured to define an opening the area of the opening being equal to, or substantially equal to, an area within a perimeter of gripper fingers on the nest when those gripper fingers grip an electronic component, so that in its closed position the shutter overlays at least the majority of nest on which the electronic component is supported so that the shutter can prevent light emitted by the electronic component from being diverted away from the enclosure of the testing device by at least the majority of the nest.

The shutter may be configured to define an opening the area of the opening being equal to, or substantially equal to, an area within a perimeter of gripper fingers on the nest when those gripper fingers grip an LED, so that in its closed position the shutter overlays at least the majority of nest on which the LED is supported so that the shutter can prevent light emitted by the LED from being diverted away from the integrating sphere by at least the majority of the nest.

The shutter may comprise a first sliding door and a second sliding door which are arranged opposite to one another, wherein the first and second doors each comprising a cut out portion which together define said opening when the shutter is in its closed position.

For example, if the LED to be tested has a cross section which is square-shaped, the cut-out portions on the first and second doors may each be rectangular shaped; each rectangular cut-out portion having an area dimension which is equal to half the area dimension of the square-shaped cross section of the LED, so that when the shutter is in its closed position an opening being the same shape and area as the shape and area of a cross section of the LED, will be defined. It will be understood that the cut-out portions may be any suitable shape or dimension depending on the shape of the cross section of the LEDs to be tested; for example if the LEDs to be tested are of circular cross section, then the cut-out portions on the first and second doors will each be semi-circular shaped; each semi-circular cut-out portion having an area dimension which is equal to half the area dimension of the circular-shaped cross section of the LED, so that when the shutter is in its closed position an opening being the same shape and area as the shape and area of a cross section of the LED, will be defined. In such a case the first and second doors will overlay substantially the whole of the nest on which the LED is supported, so as to block light emitted from the LED from being incident on the nest, while the area of the opening will allow light emitted from the LED to enter into the sphere. The shutter will thus prevent light which is emitted by the LED during testing from being diverted away from the integrating sphere by the majority of the nest on which the LED is supported, so that more accurate testing of the light characteristics of the LED can be achieved.

It will be understood that the shape of opening may correspond to the shape and dimensions of the LED under tests (e.g. shape and area of a cross section of the LED) and/or may correspond to the shape and dimensions of a perimeter of gripping fingers which grip the LED to be tested. The shape and dimensions of the perimeter of gripping fingers which grip the LED to be tested may be any suitable shape and dimension, and the corresponding shaped opening will be achieved by providing suitably shaped and dimensioned cut-out portions in the first and second doors, as described above. The perimeter of gripping fingers which grip the LED to be tested may be any suitable shaped, for example, hexagonal, rectangular or circular shaped; preferably the perimeter of gripping fingers which grip the LED to be tested will be circular shaped.

For example, if the gripper fingers have a square-shaped perimeter when they grip an LED, then cut-out portions on the first and second doors may each be rectangular shaped; each rectangular cut-out portion having an area dimension which is equal to half the area within the perimeter, so that when the shutter is in its closed position an opening being the same shape and area as the shape and area of the perimeter of the gripper fingers, will be defined. It will be understood that the cut-out portions may be any suitable shape or dimension depending on the shape and dimension of the perimeter of the gripper fingers when they grip an LED; for example if perimeter of the gripper fingers when they grip an LED is circular, then the cut-out portions on the first and second doors will each be semi-circular shaped; each semi-circular cut-out portion having an area dimension which is equal to half the area within the perimeter, so that when the shutter is in its closed position an opening being the same shape and area as the shape and area of the perimeter of the gripper finger, will be defined. In such a case the first and second doors will overlay the majority of the nest on which the LED is supported, only the gripper fingers and the LED being exposed to the inside of the integrating sphere. Thus the shutter will block light emitted from the LED from being incident on the majority of the nest, while the area of the opening will allow light emitted from the LED to enter into the sphere. The shutter will thus prevent light which is emitted by the LED during testing from being diverted away from the integrating sphere by the majority of the nest on which the LED is supported, so that more accurate testing of the light characteristics of the LED can be achieved.

The shutter may be configured to define an opening when in its closed position, the opening having being circular shaped and having a diameter within the range 0.5 mm-10 mm.

The shutter may be configured to define an opening when in its closed position, the opening having is circular shaped having a diameter within the range 0.5 mm-10 mm. Such is achieved by providing semi-circular cut-out portions which have a radius within the range 0.25 mm-5 mm. Most preferably the diameter of the opening is 4 mm; such is achieved by providing semi-circular cut-out portions which each have a radius 2 mm. The shutter may be configured to define an opening when in its closed position, the opening being square shaped, the length of each side of the square being within the range 0.5-10 mm. Such is achieved by providing rectangular cut-out portions which have a longest side within the range 0.5-10 mm and shortest side within the range 0.25 mm-5 mm. Most preferably the length of each side of the opening is 4 mm; such is achieved by providing rectangular cut-out portions which have a longest side of length 4 mm and shortest side of length 2 mm. The shutter may be configured to define an opening when in its closed position, the opening having a rectangular shaped with a length dimension within the range 0.5 mm-10 mm and a width dimension within the range 0.5 mm-10 mm. The rectangular opening again may be achieved by providing the appropriately dimensioned cut-out portions in the first and second doors of the shutter. The opening may have any suitable shape or dimensions; the shape and dimensions of the opening is determined by the shape and dimensions of the cut-out portions provided in the first and second doors.

The shutter may be configured to define an opening when in its closed position, the largest dimension of the opening being substantially equal to the largest dimension of a cross section of the LED to be tested, so that in its closed position the shutter overlays at least the majority of nest on which the LED is supported so that the shutter can prevent light emitted by the LED from being diverted away from the integrating sphere by at least the majority of the nest.

The shutter may be configured to define an opening when in its closed position, the largest dimensions of the opening being substantially equal to the diameter of gripper fingers on a nest which can grip an LED to be tested, so that in its closed position the shutter overlays at least the majority of nest on which the LED is supported so that the shutter can prevent light emitted by the LED from being diverted away from the integrating sphere by the majority of the nest.

Preferably the thickness of each of first and second sliding doors is between 0.15 mm-0.25 mm. Preferably the thickness of each of first and second sliding doors is 0.2 mm.

The shutter may be configured such that the first and second sliding doors can both abut each other, and abut the gripper fingers of a nest which holds the LED to be tested, when the shutter is in its closed position, to hermetically close the light integrating sphere. It will be understood that the gripper fingers may hold an LED by clamping; for example opposing fingers may clamp the LED.

One of the doors may comprise a concave end and the opposite door may comprise a convex end so that the opposing sliding doors define a curved channel between the doors when the shutter is in its first open position, so that an LED to be tested can be moved along a curved path into and out of the inlet.

The first and second doors may each have a curved profile which corresponds to the curved profile of the integrating sphere. The first and second doors may each have a curved profile so that when the shutter is closed the doors will for a partial sphere. This will ensure that the integrating sphere which comprises the shutter located at its inlet will maintain a substantially sphere shape when the shutter is closed. This is in contrast to if the first and second doors has a planar profile in which case the integrating sphere would have a cut-spherical profile as the first and second doors would form a plane when the shutter is in its closed position.

The shutter may further comprise at least one pivotable member which is arranged to pivot at a centre point along the length of the pivotable member wherein one end of the pivotable member mechanically cooperates with the first door and the second opposite end of the pivotable member mechanically cooperates with the second door, so that sliding either of the first or second doors in one direction will cause the pivotable member to pivot thereby causing the other door to slide in the opposite direction.

The shutter may comprise two pivotable members each of which is arranged to pivot at a centre point along each of their respective lengths, wherein one end of each pivotable member mechanically cooperates with the first door and the second, opposite end of each pivotable member mechanically cooperates with the second door, so that sliding either of the first or second doors in one direction will cause both pivotable members to pivot thereby causing the other door to slide in the opposite direction.

The first door may comprise a c-shaped member which defines an aperture, and wherein the at least one pivotable member and the second door are positioned within the aperture.

Preferably the at least one pivotable member and the second door are contained completely within the aperture.

The c-shaped member may further comprise a projection, and the second door further comprises a recess which can receive the projection. The projection and recess will preferably cooperate to guide the movement of the first and second doors relative to one another.

The shutter may further comprise an actuating means which is operable to move the shutter between its first open position and second closed position, wherein the actuating means comprises a biasing means which biases the shutter towards its first open position and a pusher which is operable to push the shutter towards its second closed position against the biasing force of the biasing means.

The biasing means may comprise a spring. Preferably the spring is arranged to abut a first edge of the first door.

The pusher may comprise a rotatable cam and a cam follower, wherein the cam follower is arranged to mechanically cooperate with a door of the shutter. Preferably the cam follower may be arranged to mechanically cooperate with the first door of the shutter. Preferably the cam follower is arranged to mechanically cooperate with the first door of the shutter by abutting a second edge of the door. Preferably the second edge is opposite to the first edge.

The light integrating sphere may further comprise a controller which synchronizes closing of the shutter and operation of the light integrating sphere to measure the light characteristics of an LED.

The light integrating sphere may further comprise a glass dome which is located within the light integrating sphere and is located over the shutter.

According to a further aspect of the present invention there is provided an assembly comprising

a testing device having one or more of the above-mentioned features, and

a rotatable table comprising a plurality of nests on each of which an electronic component can be supported, wherein each nests comprises gripper fingers which can hold an electronic component, wherein the rotatable table is arranged such that it can rotate to move an electronic component held by a gripper fingers on a nest into the inlet of the light integrating sphere for testing when the shutter is in its open position.

The testing device is preferably a light integrating sphere. Preferably the electronic component is an LED.

Each nest may comprise two opposing gripper fingers. The two opposing gripper fingers may be operable to clamp an LED to hold the LED on said nest. Each of the gripper fingers may be defined by a projection which extends from a surface of the nest. Each projection may have a height between 0.1 mm-0.4 mm.

Each of the gripper fingers may have an outer edge. The outer edge of each gripper finger may be of any suitable shape. For example the outer edge of each finger may be square, semi-circular, or rectangular shaped, so that when the gripper fingers clamp the LED the outer edges of the gripper fingers define a rectangular, circular or square perimeter respectively, around the gripper fingers collectively. Preferably the gripper fingers each have a semi-circular outer edge so that when the gripper fingers clamp an LED the semi-circular outer edges define a circular perimeter.

The shutter may be configured to define an opening when in its closed position, the shape and area of the opening being equal to, or substantially equal to, the shape of, and area within, a perimeter of gripper fingers of a nest when the gripper fingers hold an LED, so that in its closed position the shutter overlays the majority of nest on which the LED is supported so that the shutter can prevent light emitted by the LED from being diverted away from the integrating sphere by the majority of the nest.

Each of the fingers may comprise an inner edge which abuts the LED when the gripper fingers clamp the LED. Preferably the inner edge of each gripper finger is shaped complimentary to a surface of the LED which is abuts.

The shutter may be configured to define an opening the shape of the opening being the same shape, or substantially the same shape, as the shape of the perimeter of abutting gripper fingers on the nest which grip the LED, so that in its closed position the shutter overlays at least the majority of nest on which the LED is supported so that the shutter can prevent light emitted by the LED from being diverted away from the integrating sphere by at least the majority of the nest. The shutter may be configured to define an opening the area dimension of the opening being the same as the area dimensions, or substantially the same area dimensions, as the area within a perimeter of gripper fingers on the nest which grip the LED, so that in its closed position the shutter overlays at least the majority of nest on which the LED is supported so that the shutter can prevent light emitted by the LED from being diverted away from the integrating sphere by at least the majority of the nest. The shutter may be configured to define such an opening by providing cut-out portions with suitable shape and dimensions as discussed above. For example if the perimeter of abutting gripper fingers is circular, the shutter may be configured to define an opening when in its closed position, the diameter of the opening being substantially equal to the diameter of the perimeter of the gripper fingers of a nest when the gripper fingers are clamping an LED to be tested, so that in its closed position the shutter overlays the majority of nest on which the LED is supported so that the shutter can prevent light emitted by the LED from being diverted away from the integrating sphere by the majority of the nest. To achieve this each of the first and second doors of the shutter may be provided with a semi-circular cut-out portion, each of which have a radius which is substantially equal to half the radius of the diameter of the perimeter of the gripper fingers of a nest when the gripper fingers are clamping an LED to be tested.

The gripper fingers of a nest may comprise a non-reflective surface. For example the gripper fingers may comprise a coating of non-reflective material.

The assembly may further comprise a controller which synchronizes opening of the shutter and rotation of the rotatable table.

The rotatable table may further comprise a heater which can heat the LED as it is being tested in the light integrating sphere.

It will be understood that the shutter of the assembly may have one or more of the features of the shutter of any of the testing devices mentioned above, and/or may have one or more of the features of the shutter described in the example described in the detailed description section below, and/or any one or more of the features mentioned in the dependent claims.

According to a further aspect of the present invention there is provided a shutter, suitable for a light integrating sphere which is used for measuring the light characteristics of an electronic component, wherein the shutter configured to be moveable between a first open position and a second closed position, wherein, in the first open position an electronic component to be tested can be passed through the opened shutter, and in the second closed position, the shutter can overlay at least the majority of a nest on an electronic component to be tested is supported, so that the shutter can prevent light emitted by the electronic component from being diverted away from the integrating sphere by at least the majority of the nest, wherein the shutter comprises cut-out portions which define an opening which can accommodate the electronic component to be tested when the shutter is in its second closed position.

The electronic component is preferably an LED.

It will be understood that the shutter may have one or more of the features of the shutter of any of the testing devices mentioned above, and/or may have one or more of the features of the shutter described in the example described in the detailed description section below, and/or any one or more of the features mentioned in the dependent claims. For example, cut-out portions of the shutter may define an opening the shape of the opening being the same shape, or substantially the same shape, as the shape of the perimeter of gripper fingers on the nest which grip the LED. The shutter may be configured to define an opening the area of the opening being equal to, or substantially equal to, the area of a cross section of the LED to be tested.

It will be understood that the above-mentioned shutter, assembly and testing device, are not limited to use with LEDs, rather they can be configured for use with any type of electronic component whose light characteristics are to be tested.

### BRIEF DESCRIPTION OF THE DRAWINGS

The invention will be better understood with the aid of the description of an embodiment given by way of example and illustrated by the figures, in which:

FIG. 1 shows a perspective view of an assembly according to an embodiment of an aspect of the present invention;

FIG. 2 shows a cross sectional-view of an end portion of the light integrating sphere used in the assembly of FIG. 1, wherein the shutter of the light integrating sphere is shown to be in its open position;

FIG. 3 shows a cross sectional-view of an end portion of the light integrating sphere used in the assembly of FIG. 1, wherein the shutter of the light integrating sphere is shown to be in its closed position;

FIG. 4 which shows a magnified cross sectional view of the region of the opening in FIG. 3;

FIG. 5 provides a perspective view of the shutter from beneath the light integrating sphere, wherein the shutter is shown in its open position.

FIG. 6 provides a perspective view of the shutter from beneath the light integrating sphere, wherein the shutter is shown in its closed position;

FIG. 7 provides a perspective view of a curved channel, define by the convex and concave ends of the doors of the shutter, which is provided when the shutter is in its open position;

FIG. 8a,b provide perspective views of a pusher and its rotatable cam and cam follower which is operable to move the shutter to its closed position.

### DETAILED DESCRIPTION OF POSSIBLE EMBODIMENTS OF THE INVENTION

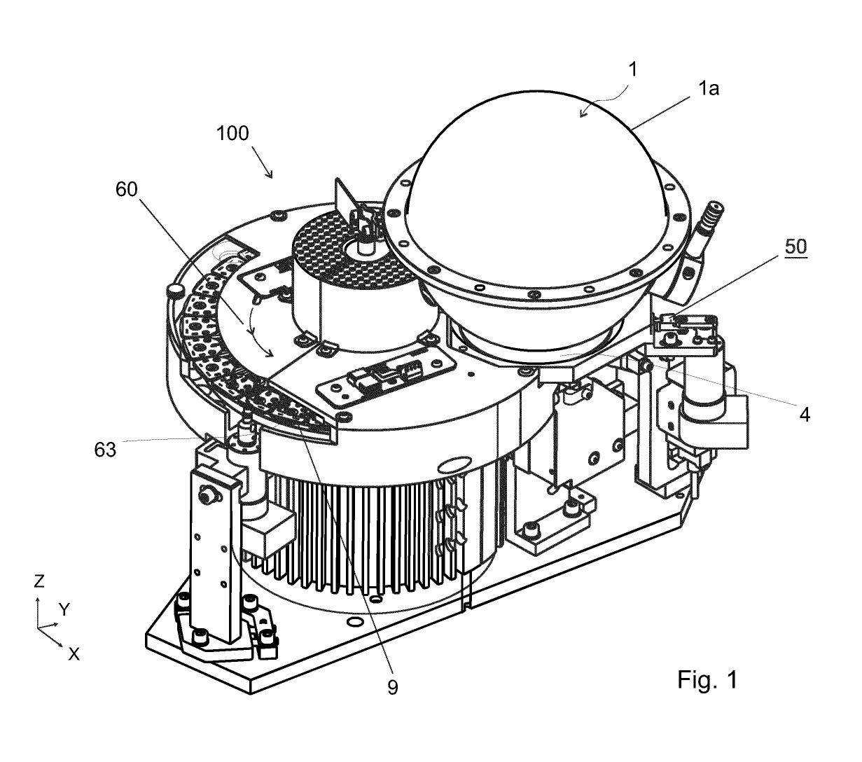

FIG. 1 provides a perspective view of an assembly 100 according to an embodiment of an aspect of the present invention. The assembly 100 comprises a testing device 1 according to an embodiment of another aspect the present invention in the form of a light integrating sphere 1 for measuring the light characteristics of an LED 3. The testing device 1 comprises an enclosure 1a.

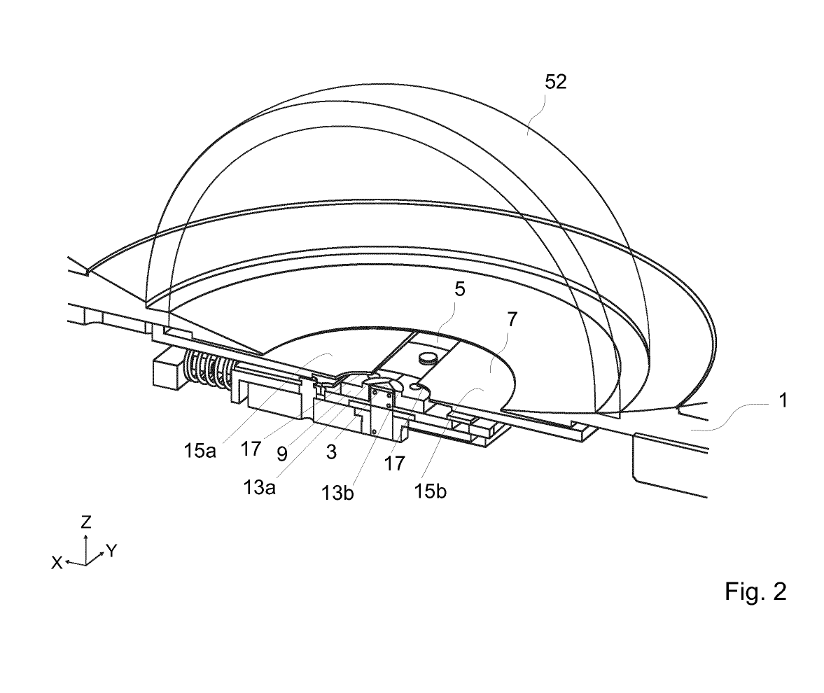

An exemplary embodiment of the a testing device 1 in the form of a light integrating sphere 1, when in use to test electronic components in the form of LEDs, will now be described in more detail with reference to FIGS. 2-8a,b. However it should be understood that the present invention is not limited to integrating spheres which are used to test LEDs; the present invention may be used with any testing device which is used to test any type of electrical component and which has an enclosure which is required to be selectively opened and closed.

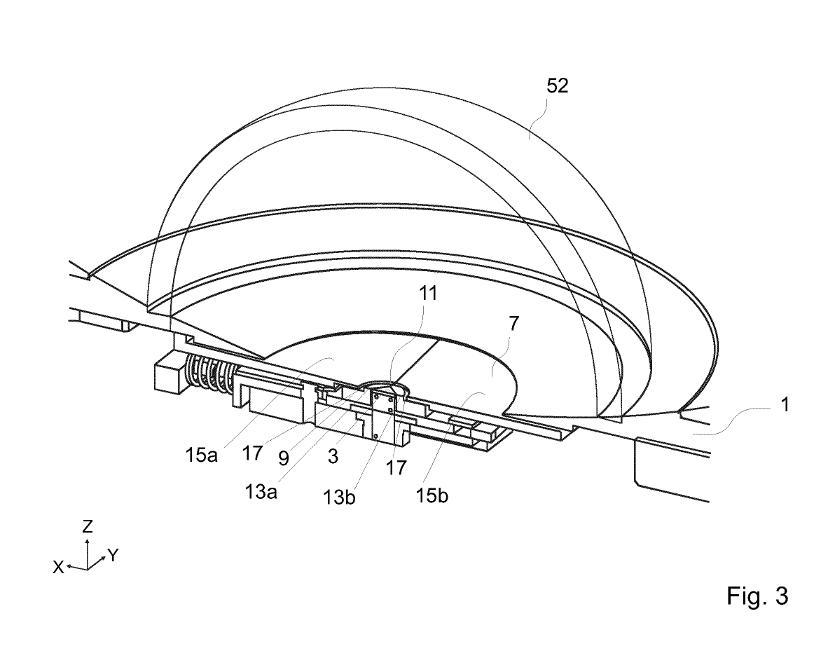

FIGS. 2 and 3 each provide a cross sectional view of an end portion 4 of the light integrating sphere 1 used in the assembly 100 of FIG. 1. As illustrated the light integrating sphere 1 comprises a spherical enclosure la (as can be best seen in FIG. 1) and an inlet 5 at which an LED 3 can be presented to the light integrating sphere 1 for testing. A shutter 7 according to an embodiment of a further aspect of the present invention, is provided at the inlet 5 of the light integrating sphere 1. The shutter 7 is configured to be moveable between a first open position in which an LED 3 to be tested can be received into the inlet 5, and a second closed position in which the shutter 7 can overlay at least the majority of a nest 9 on which said LED 3 is supported, so that the shutter 7 can prevent light emitted by the LED 3 from being dispersed by at least the majority of the nest 9. In particular, the shutter 7 can prevent light which is emitted by the LED 3, from being diverted away from the integrating sphere by the majority of the nest 9. FIG. 2 illustrates the shutter 7 in its first open position and FIG. 3 illustrates the shutter in its second closed position. The integrating sphere 1 further comprises a controller 50 (illustrated in FIG. 1) which synchronizes closing of the shutter 7 and operation of the light integrating sphere to measure the light characteristics of an LED.

The shutter 7 comprises a first sliding door 15a and a second sliding door 15b which are arranged opposite to one another, wherein the first and second doors 15a,b each comprise a cut-out portion 17 which together define said opening 11 when the shutter 7 is in its closed position, as shown in FIG. 3. While in the present example the shutter 7 comprises a first sliding door 15a and a second sliding door 15b it will be understood that in an alternative embodiment the shutter may comprise a single sliding door which has a cut-out portion. In another embodiment the shutter may comprise more than two sliding doors, and some or all of said sliding doors may have cut out portions.

The light integrating sphere 1 further comprises a glass dome 52 which is located within the light integrating sphere and is located over the shutter 7. The glass dome 52 will prevent dust within the integrating sphere 1 from falling onto the LED 3 which is under test; dust falling on the LED would otherwise adversely affect the test results.

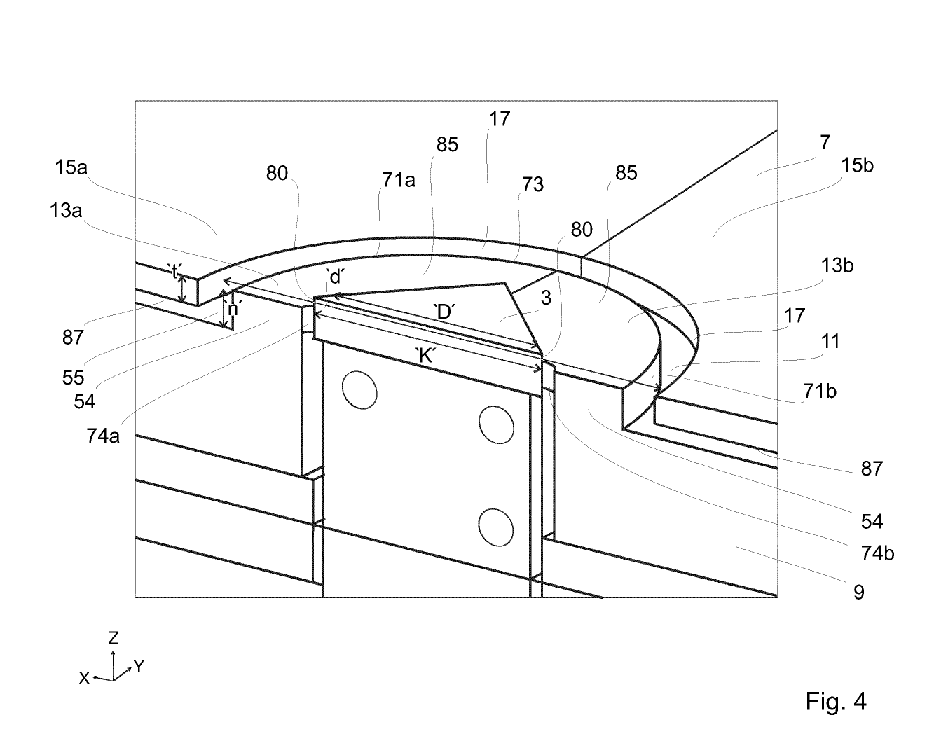

As can be seen in FIGS. 2 and 3 the LED to be tested is supported on a nest 9. The nest 9 comprises two opposing gripper fingers 13a,b which can be best seen in FIG. 4 which shows a magnified cross sectional view of the region of the opening 11 in FIG. 3, when the shutter 7 is in its closed position. The nest 9 is shown in FIG. 4 to have two opposing gripper fingers 13a,b; the fingers 13a,b are operable to clamp an LED 3 to hold the LED 3 on said nest 9. Each of the gripper fingers 13a,b is defined by a projection 54 which extends from a surface 55 of the nest 9. In this example each projection 54 has a height ‘h’ of between 0.1 mm-0.4 mm from the surface 55 of the nest 9. The gripper fingers 13a,b each have a have a semi-circular outer edge 71a,b so that when the gripper fingers clamp the LED the semi-circular outer edges define a circular perimeter 73; however it will be understood that the outer edge 71a,b of the gripping fingers 13a,b may have any other shape, for example the outer edge 71a,b may be square shaped, rectangular shaped or triangular shaped. Each of the fingers 13a,b comprise an inner edge 74a,b which abuts the LED 3 at its side surface 80 to clamp the LED 3 between the gripper fingers 13a,b. The inner edge 74a,b of each gripper finger 13a,b is shaped complimentary to a shape of the side surface 80 of the LED 3 which is abuts. Finally the gripper fingers 13a,b of a nest each comprise a non-reflective surface 85.

The shutter 7 is configured such that the diameter ‘d’ of the opening 11 which is defined by the cut-out portions 17 of each door 15a,b, is substantially equal to the largest dimension ‘D’ of a cross section of the LED 3 to be tested, so that in its closed position the shutter 7 overlays at least the majority of nest 9 on which the LED 3 is supported so that the shutter 7 can prevent light emitted by the LED 3 from being dispersed by at least the majority of the nest 9 and in particular prevent the light from being diverted away from the integrating sphere. In this particular example the shutter 7 is configured such that the diameter ‘d’ of the opening 11 which is defined by the cut-out portions 17 of each door 15a,b, is substantially equal to the diameter ‘K’ of gripper fingers 13a,b on a nest 9 which grip the LED 3 to be tested, so that in its closed position the shutter 7 overlays at least the majority of nest 9 on which the LED 3 is supported so that the shutter 7 can prevent light emitted by the LED from being dispersed by the majority of the nest 9 and in particular prevent the light from being diverted away from the integrating sphere by the majority of the nest 9. The shutter 7 is configured to define such an opening 11 by providing a cut-out portion 17 on each of the first and second doors 15a,b which have the appropriate shape and dimension; for example each cut-out portion 17 may be configured have both, a shape which is substantially complimentary to the shape of a respective outer edge 71a,b of a gripping finger 13a,b, and a dimension which is substantially equal to the dimensions of a respective outer edge 71a,b of a gripping finger 13a,b (e.g. dimensions such as the height ‘h’ of the outer edge 71a,b, the length of the outer edge 71a,b and the curvature of the outer edge 71a,b. In this case area of the opening 11 will be substantially equal to the area defined by the perimeter 73 of the gripper fingers 13a,b (which is defined by the outer edges 71a,b of the gripper fingers 13a,b) when the gripper fingers 13a,b grip the LED 3. In this example the shutter 7 is configured to define an opening 11 when in its closed position, which has a diameter ‘d’ of 4 mm. It will be understood that the shutter 7 could be configured to define an opening 11 when in its closed position, which has any suitable diameter ‘d’ length, for example the diameter length may be within the range 0.5-10 mm. The shutter 7 is configured to define an opening 11 when in its closed position, which has a diameter ‘d’ of 4 mm by having a semi-circular cut-out portion 17 in each of the first and second doors 15a,b each of which has a radius of 2 mm. Preferably this thickness ‘t’ of each of first and second sliding doors is substantially equal to the height ‘h’ of each of the gripping finger 13a,b and, more specifically is equal to the height ‘h’ of the each of the projections 54 which define the gripping finger 13a,b; in this example the thickness ‘t’ of each of first and second sliding doors is 0.2 mm however it will be understood that the doors 15a,b may have any suitable thickness for example the thickness ‘t’ may be between 0.15 mm-0.25 mm.

While in this example the opening 11 is described as being circular, it should be understood that the opening 11 could be any suitable shape e.g. square, hexagonal, or rectangular etc. It should be understood that the shape and dimensions of the opening 11 may correspond to the LED 3 and/or may correspond to the gripper fingers 13a,b; in other words the shape and area of the opening 11 may be substantially equal to the shape and area of a cross section of the LED 3 and/or may be substantially equal to the shape of, and area within, the perimeter 73 of the gripper fingers 13a,b (which is defined by the outer edges 71a,b of the gripper fingers 13a,b) when the gripper fingers 13a,b grip the LED 3. In both cases the shutter 7 can overlay a majority of the nest 9.

The under-surface 87 of each of the first and second doors 15a,b will abut the nest 9 when the shutter is in its closed position to hermetically close the light integrating sphere 1. Although it is not illustrated in FIG. 4, it should be understood that the shutter 7 may be configured such that the first and second sliding doors 15a,b abut both each other, and also abut the edge 71a,b of a respective gripper finger 13a,b which holds the LED 3 to be tested, when the shutter 7 is in its closed position, to hermetically close the light integrating sphere 1.

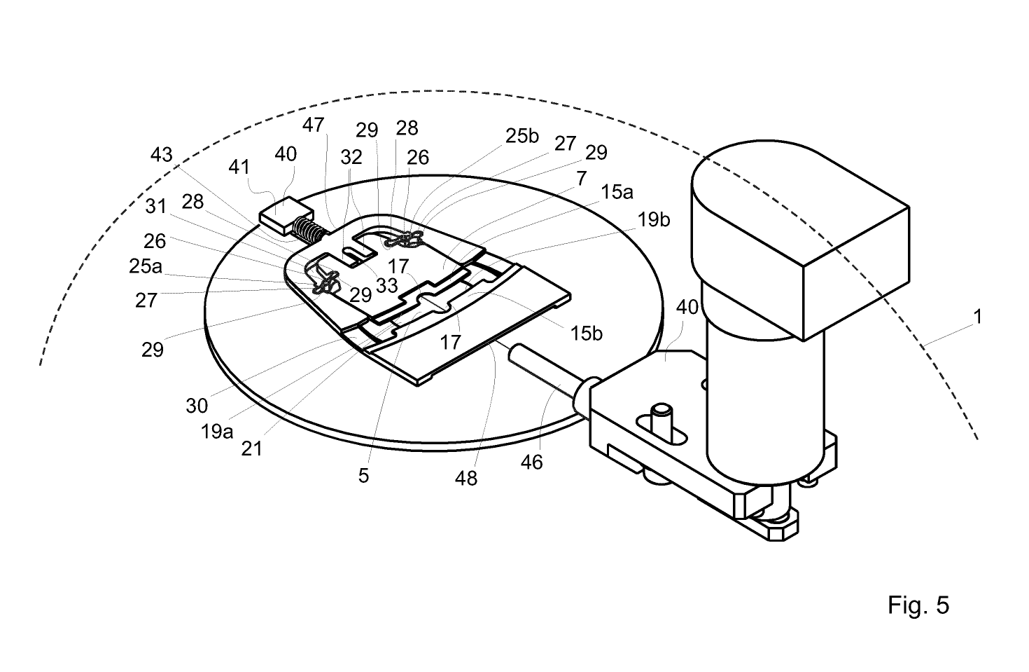

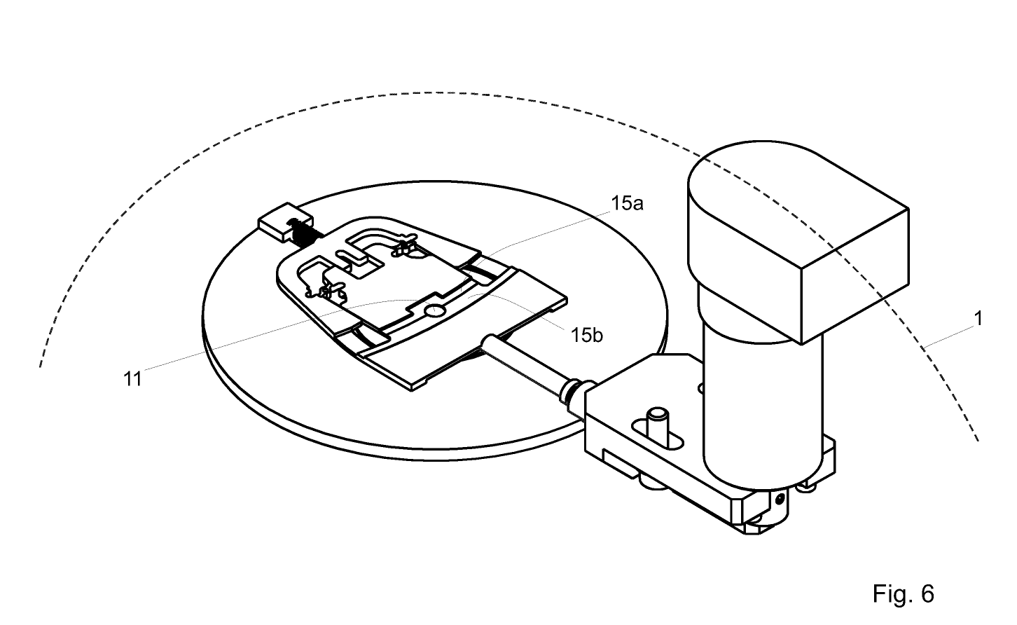

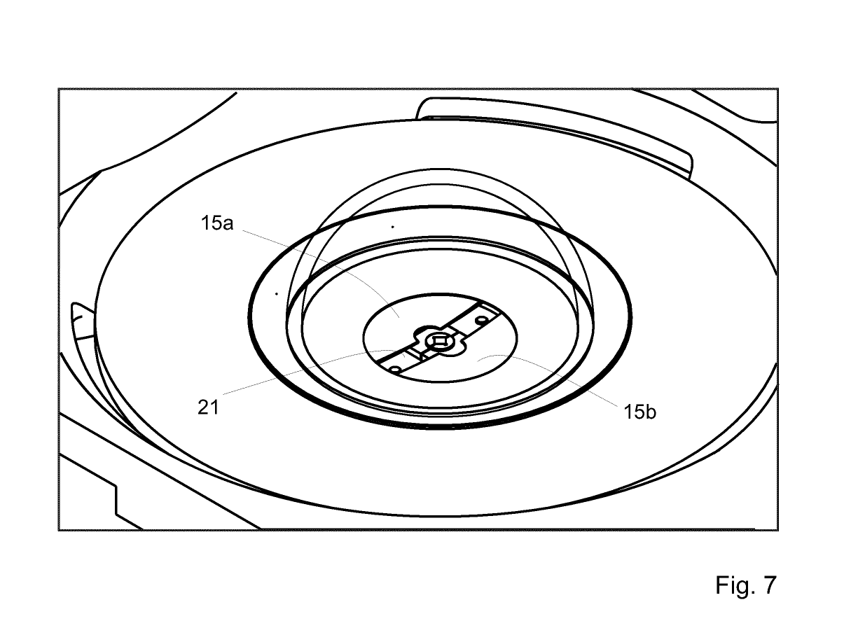

FIGS. 5 and 6 each provide a perspective view of the shutter 7 of beneath the light integrating sphere 1. FIG. 5 illustrates the shutter 7 in its first open position and FIG. 6 illustrates the shutter in its second closed position.

As can be clearly seen in FIG. 5 the first door 15b of the shutter comprises a concave end 19b and the opposite second door 15a of the shutter 7 comprises a convex end 19a, so that the opposing sliding doors 15a,b define a curved channel 21, between the first and second doors 15a,b, when the shutter 7 is in its first open position. This curved channel 21 allows an LED 3 to be tested to be moved along a curved path into and out of the inlet 5. The curved channel 21 thus allows an LED 3 to be moved into the inlet 5 of the light integrating sphere 1 by means of a rotating table which rotates to move an LED 3 to be tested into the inlet 5 of the light integrating sphere 1. The curved channel 21 is also illustrated in FIG. 7.

FIGS. 5 and 6 provide a more detailed illustration of the features of the shutter 7. The shutter 7 further comprises at least one pivotable member 25a,b which is arranged to pivot at a centre point 26 along the length of the pivotable member 25a,b. In this example the shutter further comprises two pivotable members 25a,b. Each pivotable member 25a,b is arranged to pivot at a centre point 26 along its respective length. One end 27 of each pivotable member 25a,b mechanically cooperates with the first door 15a of the shutter 7 and the second, opposite end 28 of each pivotable member 25a,b mechanically cooperates with the second door 15b, so that sliding either of the first or second doors 15a,b in one direction will cause both pivotable members 25a,b to pivot about their respective centre points 26, thereby causing the other door 15a,b to slide in the opposite direction. The ends 27,28 mechanically cooperate with the first and second door 15a,b as each of the first and second door 15a,b comprise sockets 29 which receive the ends 27,28. The sockets 29 are dimensioned to allow the ends 27,28 to rotate within the sockets 29.

The first door 15a comprises a c-shaped member 30 which defines an aperture 31. The pivotable members 25a,b and the second door 15b are positioned within the aperture 31. In this example the pivotable members 25a,b and the second door 15b are contained completely within the aperture 31.

The c-shaped member 30 further comprises a projection 32, and the second door 15b further comprises a recess 33 which receives the projection 32. The projection 32 and recess 33 cooperate to guide the movement of the first and second doors 15a,b relative to one another.

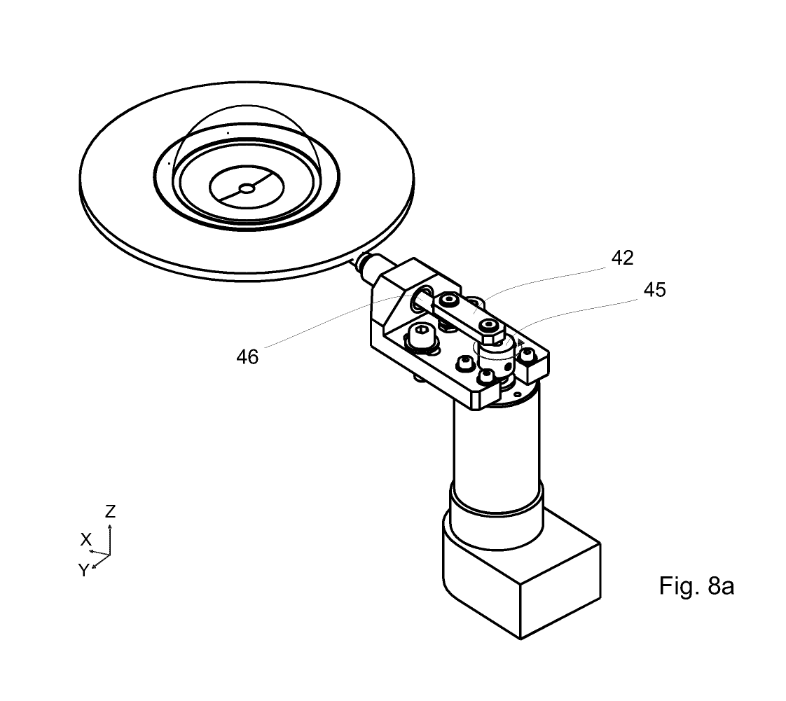

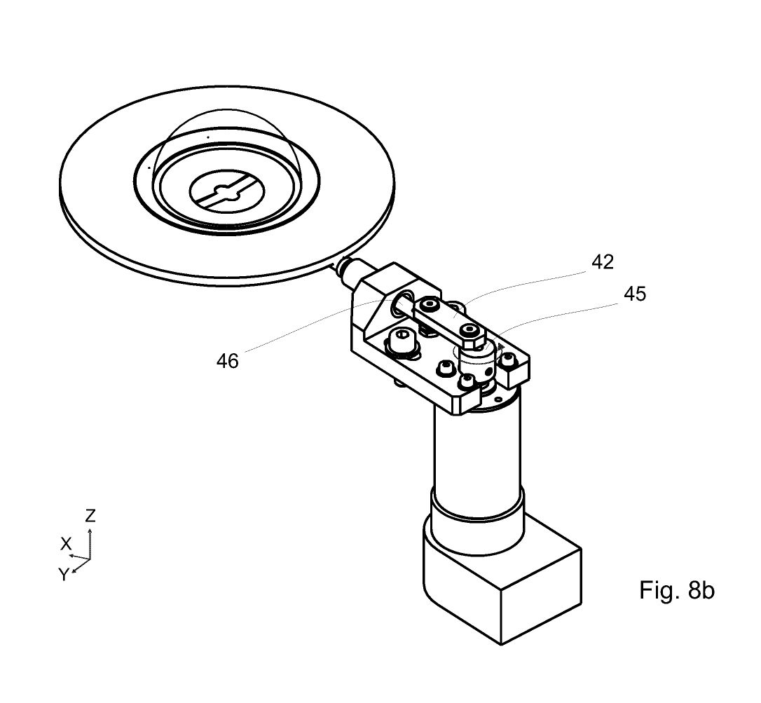

An actuating means 40 is further provided which is operable to move the shutter 7 between its first open position and second closed position. The actuating means 40 comprises a biasing means 41 which biases the shutter 7 towards its first open position and a pusher 46 which is operable to push the shutter 7 towards its second closed position against the biasing force of the biasing means 41. In this example the biasing means 41 comprises a spring 43; the spring 43 is arranged to abut a first edge 47 of the first door 15a. The pusher 46 comprises a rotatable cam 45 and a cam follower 42, wherein the cam follower 42 is arrange to mechanically cooperate with the first door 15a of the shutter 7. The cam follower 42 is arranged to mechanically cooperate with the first door 15a of the shutter 7 by abutting a second edge 48 of the door. Preferably the second edge 48 is opposite to the first edge 47. The pusher 46 and its rotatable cam 45 and cam follower 42 is also illustrated in FIGS. 8a and 8b.

Returning now to the assembly shown in FIG. 1, the assembly 100 further comprises a rotatable table 60 which comprising a plurality of the nests 9. Each nests 9 comprises gripper fingers 13a,b which can hold an LED 3 as illustrated in FIGS. 2-4 above. Some or all of the nests may hold an LED 3 for testing. The rotatable table 60 is arranged such that it can rotate to move an LED 3 held by a gripper fingers 13a,b on a nest 9 into the inlet 5 of the light integrating sphere 1 for testing when the shutter 7 is in its open position. The curved channel 21 defined by the opposing concave end 19b and convex end 19a of the first and second doors 15a,b respectively will allow an LED 3 to be moved into the inlet 5 of the light integrating sphere 1 by means of a rotating table which, upon rotation, will move an LED 3 to be tested into the inlet 5 along the curved channel 21.

In this example the controller 50, which is configured to synchronize closing of the shutter 7 and operation of the light integrating sphere to measure the light characteristics of an LED, will also be configured to which synchronizes opening of the shutter 7 and rotation of the rotatable table 60 so as to ensure that the rotatable table 60 is rotated only when the shutter 7 is in its open position. It will be understood that two independent controllers could be provided instead one for each synchronization.

Once an LED to be tested has been moved by the rotatable table 60 into the inlet 5 of the light integrating sphere 1, the controller 50 will initiate the actuator 40 to move the shutter 7 to its closed position. When the shutter 7 has been moved to its closed position the LED will be accommodated in the opening 11; in this example, the shutter is configured such that the gripper fingers 13a,b which hold the LED 3 are also accommodated in the opening 11 when the shutter 7 is in its closed position.

The controller will then initiate powering of the LED 3 so that is emits light, and also initiates the light integrating sphere 1 to being measuring the light characteristics of an LED 3. Since, in its closed position, the shutter 7 overlays the majority of the nest 9, the shutter will block light which is emitted by the LED 3 from being incident on the majority of the nest 9. Accordingly the shutter 7 will reduce the amount light which is dispersed by nest 9, and in particular will reduce the amount of light which is diverted away from the integrating sphere by the majority of the nest 9, thereby ensuring a more accurate measurement of the light characteristics of an LED 3. In this example the shutter 7 overlays the whole of the nest 9 except for the gripper fingers 13a,b; however the gripper fingers 13a,b further comprise a non-reflective surface 85 which serves to reduce the amount of light which they disperse.

The table 60 of the assembly 100 shown in FIG. 1, further comprises a heater 63 which can optionally operated to heat the LED 3 as it is being tested in the light integrating sphere 1.

It should be understood that the shutter 7 described above could be provided mechanically independently of the light integrating sphere. The shutter may be used to open and close openings or slots in other components, other than a light integrating sphere. For example the shutter may be provided on any enclosure or housing which is used for testing components such as LEDs. It will also be understood that the shutter maybe used with other devices other than LEDs for example the shutter may be used with a light sensor which is to be enclosed in a black-box by means of the shutter.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

1. A testing device for testing electronic components, the testing device comprising:
an enclosure which has an inlet at one end at which an electronic component can be presented for testing;
a shutter located at the inlet, wherein the shutter is configured to be moveable between a first open position in which an electronic component to be tested can be received into the inlet, and a second closed position in which the shutter can overlay at least the majority of a nest on which said electronic component is supported, so that the shutter can prevent light emitted by the electronic component from being diverted away from the testing device by at least the majority of the nest,
wherein the shutter comprises at least one sliding door which can be slid to move the shutter into its first open position, and slid to move the shutter into its second closed position, wherein the at least one sliding door comprises a cut out portion which defines an opening when the shutter is in its second closed position through which light emitted by the electronic component can pass.

2. A testing device according to claim 1 wherein the testing device is a light integrating sphere for measuring the light characteristics of an electronic component which is an LED.

3. A testing device according to claim 1 wherein the shutter 7 comprises a first sliding door and a second sliding door which are arranged opposite to one another, wherein the first and second doors each comprising a cut out portion which together define said opening when the shutter is in its closed position.

4. A testing device according to claim 3 wherein the shutter is configured such that the first and second sliding doors can both abut each other, and abut the gripper fingers of a nest which holds the LED to be tested, when the shutter is in its closed position, to hermetically close the testing device.

5. A testing device according to claim 3 wherein one of the doors comprises a concave end and the opposite door comprises a convex end, so that the opposing sliding doors define a curved channel, between the doors when the shutter is in its first open position, so that an LED to be tested can be moved along a curved path into and out of the inlet.

6. A testing device according to claim 3 wherein the shutter further comprises at least one pivotable member which is arranged to pivot at a centre point along the length of the pivotable member wherein one end of the pivotable member mechanically cooperates with the first door and the second opposite end of the pivotable member mechanically cooperates with the second door, so that sliding either of the first or second doors 15a,b in one direction will cause the pivotable member to pivot thereby causing the other door to slide in the opposite direction.

7. An testing device according to claim 1 wherein the opening has the same shape and/or dimension, or substantially the same shape and/or dimension, as the shape and/or dimension of a cross section of the LED to be tested, so that in its closed position the shutter overlays at least the majority of nest on which the LED is supported so that the shutter can prevent light emitted by the LED from being diverted away from the testing device by at least the majority of the nest.

8. A testing device according to claim 1 wherein the opening has the same shape and/or dimension, or substantially the same shape and/or dimension, as the shape and/or dimension of a perimeter of a cross section of the gripper fingers on a nest when those gripper fingers grip an LED to be tested, so that in its closed position the shutter overlays at least the majority of nest on which the LED 3 is supported so that the shutter can prevent light emitted by the LED from being diverted away from the testing device by the majority of the nest.

9. A testing device according to claim 1 wherein the shutter further comprises an actuating means which is operable to move the shutter between its first open position and second closed position, wherein the actuating means comprises a biasing means which biases the shutter towards its first open position and a pusher which is operable to push the shutter towards its second closed position against the biasing force of the biasing means.

10. A testing device according to claim 1 wherein the testing device further comprises a controller which synchronizes closing of the shutter and operation of the testing device to test electronic components.

11. A shutter, suitable for a testing device which is used for measuring the light characteristics of an electronic component, wherein the shutter is configured to be moveable between a first open position and a second closed position, wherein,
in the first open position an electronic component to be tested can be passed through the opened shutter, and
in the second closed position, the shutter can overlay at least the majority of a nest on an electronic component to be tested is supported, so that the shutter can prevent light emitted by the electronic component from being diverted away from the testing device by at least the majority of the nest,
wherein the shutter comprises at least one sliding door which can be slid to move the shutter into its first open position, and slid to move the shutter into its second closed position, wherein the at least one sliding door comprises a cut out portion which defines said opening which can accommodate the electronic component to be tested when the shutter is in its second closed position.

12. A shutter according to claim 11 comprising a first sliding door and a second sliding door which are arranged opposite to one another, and which can be slid apart to move the shutter into its first open position, and slid together to move the shutter into its second closed position, wherein the first and second doors each comprise a cut out portion which together define said opening which can accommodate the LED to be tested when the shutter is in its second closed position.

13. An assembly comprising,
a testing device according to claim 1, and
a rotatable table comprising a plurality of nests on each of which an electronic component can be supported, wherein each nests comprises gripper fingers which can hold an electronic component, wherein the rotatable table is arranged such that it can rotate to move an electronic component held by a gripper fingers on a nest into the inlet of the testing device 1 for testing when the shutter is in its open position.

14. An assembly according to claim 14 further comprising a controller which synchronizes opening of the shutter and rotation of the rotatable table.
